(19) United States
(12) Patent Application Publication
(10) Pub. No.: US 2017/0023850 A1
(43) Pub. Date: Jan. 26, 2017

(54) CAMERA COVER

(71) Applicant: Darren Jones, American Fork, UT (US)

(72) Inventor: Darren Jones, American Fork, UT (US)

(21) Appl. No.: 15/153,567

(22) Filed: May 12, 2016

Related U.S. Application Data
(63) Continuation of application No. 14/729,956, filed on Jun. 3, 2015, now abandoned.
(60) Provisional application No. 62/011,529, filed on Jun. 12, 2014.

(51) Int. Cl. G03B 17/56; G02B 27/00; A45C 11/38; G03B 13/02

(52) U.S. Cl. CPC G03B 17/568; G03B 13/02; G02B 27/0006; A45C 11/38

(57) ABSTRACT

A cover or shell for a camera is disclosed and described. The cover can have multiple openings for accessing various portions of the camera so that the camera can be operated without substantially removing the cover.

### PRIORITY DATA

This application is a continuation of U.S. patent application Ser. No. 14/729,956, filed Jun. 3, 2015, which claims the benefit of U.S. Provisional Patent Application Ser. No. 62/011,529, filed on Jun. 12, 2014, each of which is incorporated herein by reference in their entirety.

### BRIEF DESCRIPTION OF THE DRAWINGS

FIGS. 1A-4 illustrate several views of a camera cover in accordance with an example of the present disclosure.

### DETAILED DESCRIPTION OF THE INVENTION

Definitions

In describing and claiming the present invention, the following terminology will be used in accordance with the definitions set forth below.

The singular forms “a,” “an,” and, “the” include plural referents unless the context clearly dictates otherwise.

As used herein, the term “about” is used to provide flexibility to a numerical range endpoint by providing that a given value may be “a little above” or “a little below” the endpoint.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The Invention

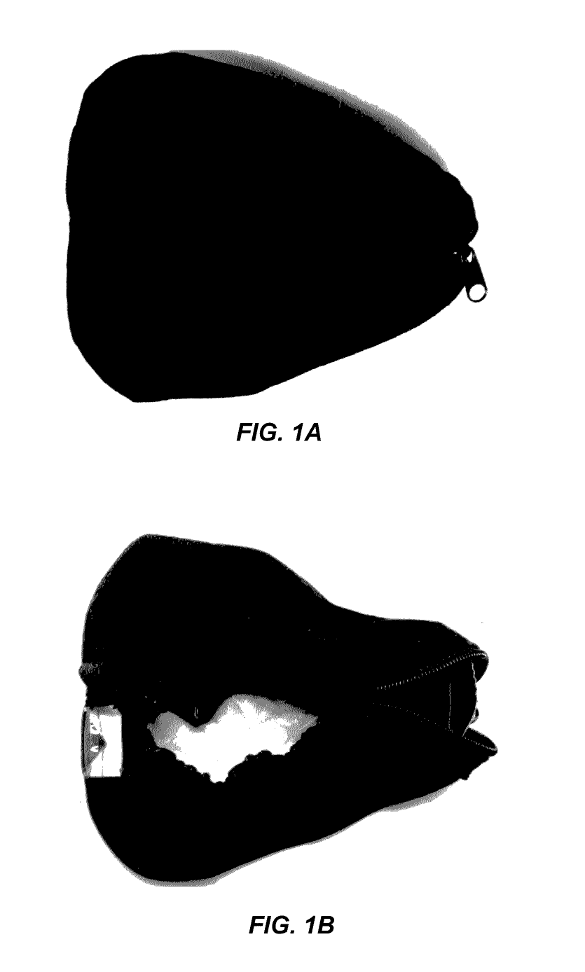

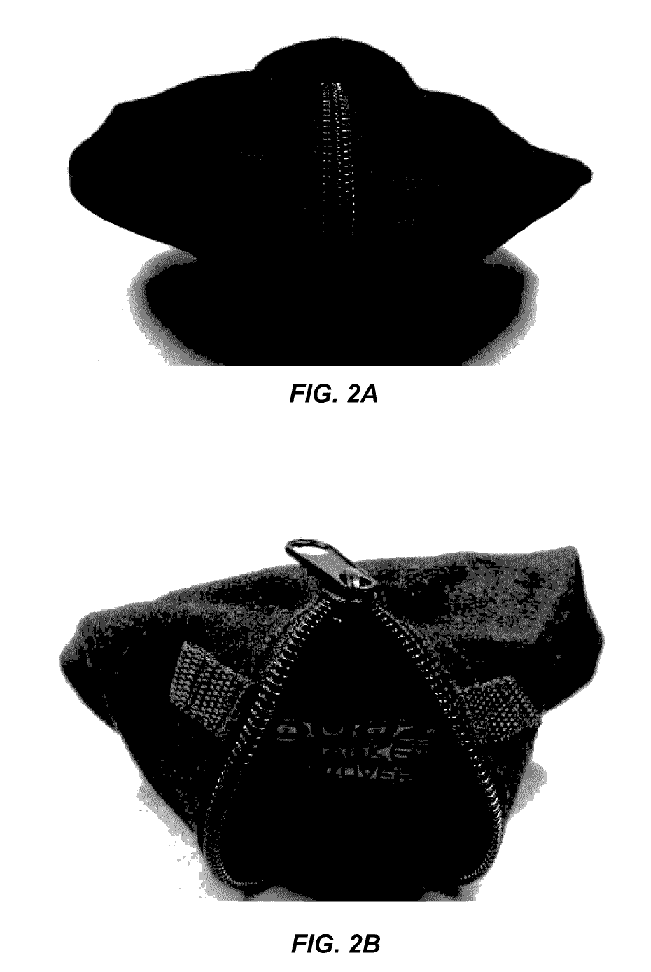

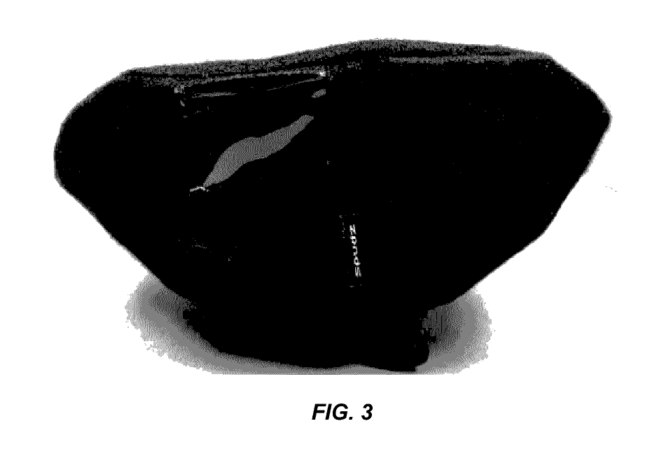

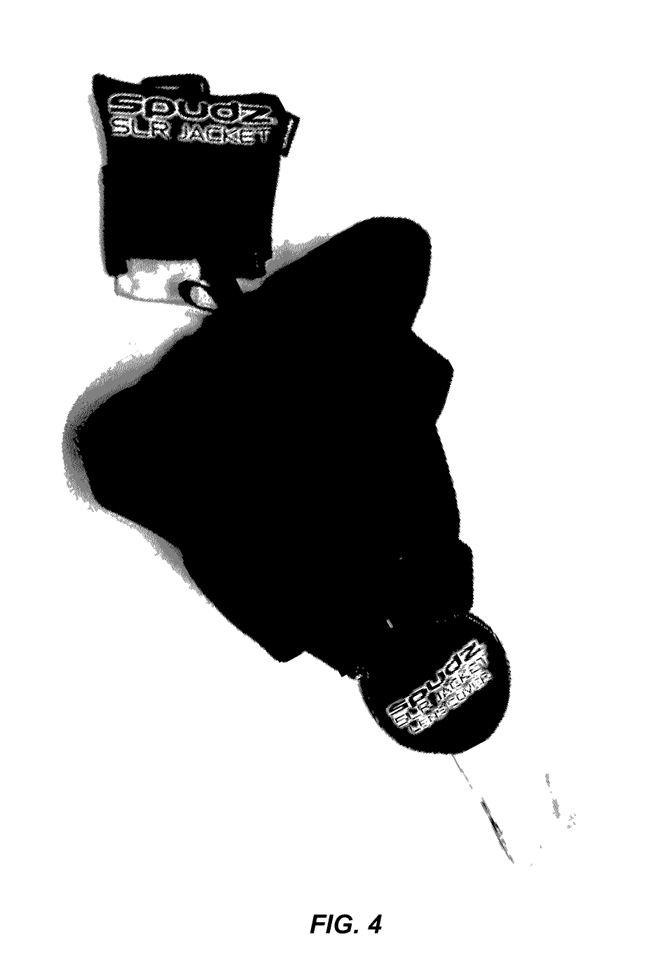

With reference to FIGS. 1A-4, illustrated is an embodiment of a camera cover in accordance with an example of the present disclosure. The camera cover can include a flexible protective shell configured to substantially cover a camera. The flexible protective shell can be configured to provide at least a water resistant barrier for the camera. The camera cover can also have a bottom opening in the flexible protective shell to receive the camera into the flexible protective shell. In one aspect, the bottom opening can be variable in size, such as with an elastic and/or a drawstring. A tab can be disposed proximate the bottom opening to facilitate disposing the camera in the flexible protective shell and/or removing the camera from the shell. An optically transparent window can be located in a rear portion of the flexible protective shell to correspond to a rear portion of the camera, which can facilitate viewing a view finder or a display on the rear portion of the camera through the protective shell. In addition, the camera cover can have a front opening in the flexible protective shell to provide an unobstructed optical path to a lens of the camera. In one aspect, the front opening can be closable to cover the lens, such as with a zipper, a hook and loop fastener, a snap, a buckle, a button, or combinations thereof In another aspect, the camera cover can include one or more tabs disposed proximate the front opening to facilitate enlarging and/or manipulating the front opening sufficient to extend a lens portion of the camera through the front opening.

In one aspect, the camera cover can include a storage receptacle coupled to the flexible protective shell. The storage receptacle can be configured to receive the flexible protective shell to form a compact storage bundle when not in use. In another aspect, the camera cover can include a lens protector coupled to the flexible protective shell to protect the lens when the front opening is closed. The lens protector can be movable to facilitate use of the camera when the front opening is open. A soft cleaning material, such as a piece of cloth or soft leather, can be coupled to the storage receptacle and/or the lens protector to clean an optical portion of the camera, such as the lens, view finder, or display. The lens protector can have a receptacle to receive and store the soft cleaning material when not in use.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A camera cover, comprising:
a flexible protective shell configured to substantially cover a camera;
a bottom opening in the flexible protective shell to receive the camera therethrough;
an optically transparent window in a rear portion of the flexible protective shell corresponding to a rear portion of the camera to facilitate viewing the rear portion of the camera through the protective shell; and
a front opening in the flexible protective shell to provide an unobstructed optical path to a lens of the camera, wherein the front opening is closable to cover the lens.

2. The camera cover of claim 1, wherein the bottom opening is variable in size.

3. The camera cover of claim 1, wherein the rear portion of the camera comprises a view finder.

4. The camera cover of claim 1, wherein the rear portion of the camera comprises a display screen.

5. The camera cover of claim 1, further comprising a storage receptacle coupled to the flexible protective shell, wherein the storage receptacle is configured to receive the flexible protective shell therein to form a compact storage bundle when not in use.

6. The camera cover of claim 5, further comprising a soft cleaning material coupled to the storage receptacle to clean an optical portion of the camera.

7. The camera cover of claim 1, further comprising a lens protector coupled to the flexible protective shell to protect the lens when the front opening is closed, wherein the lens protector is movable to facilitate use of the camera when the front opening is open.

8. The camera cover of claim 7, further comprising a soft cleaning material coupled to the lens protector to clean an optical portion of the camera.

9. The camera cover of claim 8, wherein the lens protector comprises a receptacle to receive and store the soft cleaning material when not in use.
